(19) United States
(12) Patent Application Publication
(10) Pub. No.: US 2004/0209082 A1
(43) Pub. Date: Oct. 21, 2004

(54) Process of Coating Tacky and Soft Polymer Pellets

(76) Inventors: Willy W. Lee, Bridgewater, NJ (US); John M. Meyer, Kendall Park, NJ (US); Jingping Liu, Edison, NJ (US)

Correspondence Address: WM. WRIGLEY JR. COMPANY, RESEARCH AND DEVELOPMENT, 3535 S. ASHLAND AVE., CHICAGO, IL, 60609, US

(21) Appl. No.: 10/249,539

(22) Filed: Apr. 17, 2003

(51) Int. Cl. B32B 27/02

(52) U.S. Cl. 428/407; 428/403; 427/189; 426/89

(57) ABSTRACT

An improved process of coating tacky or soft polymer pellets to maintain a free-flowing property, uses a liquid binder, in conjunction with an anti-tack or partitioning powder such as talc to prevent aggregation during storage. The binder is a non-volatile material such as an oil or plasticizer including triglycerides, mono-/di-glycerides, acetylated mono-/di-glycerides, fatty acids, epoxidized triglycerides, phthalates, benzoates, sebacates, lactates, citrates, mineral oils etc. Applications of this process include chewing gum bases, hot-melt adhesives, sealants, rubber masterbatches, powdered rubber, and other soft and tacky polymer materials.

### BACKGROUND OF INVENTION

Pelletizing is a popular forming process for manufacturing plastics and rubber compounds, due to the fact that pellet is a convenient form for downstream further processing. A common practice is to pelletize the material with an underwater pelletizer, then separate the water in a spin dryer. However, some plastics and rubber compounds are soft of tacky at ambient temperature causing blocking where individual pellets fuse into a single mass. To prevent this problem, an anti-tack or partitioning agent can be coated onto the pellet surface after forming. This is also true in preparing powdered rubber.

Common choices of anti-tack or partitioning agents include talc, magnesium silicate, calcium silicate, calcium carbonate and silica. They are in fine powder form, with a typical particle size from 0.1 to 20 microns. The small amount of moisture on the pellet surface after exiting the spin-dryer helps hold the anti-tack agent onto the pellet surface.

It has been found, however, that the moisture gradually evaporates during storage and transportation, which causes the anti-tack agent to fall off the pellet surface. As a consequence, the pellets may become tacky and block, resulting in loss of free-flow ability. This is highly undesirable in today's fast-pace downstream manufacturing facility. In addition, the free fine anti-tack powder may also be a hazard to the downstream working environment.

There have been attempts to increase free-flow in several industries. U.S. Pat. No. 6,228,902, herein incorporated by reference, discloses the application of anti-stick additives to tacky polymer particles. The additive is an emulsion of amides, ethylene bisamides, waxes, talc and silica.

U.S. Pat. No. 5,041,251 discloses soft, tacky plastic being contacted by a fluid with a non-sticky agent. The material is cooled, cut and then exposed to a second non-sticky agent. The non-sticky material are silicones, surfactants, powders, powdered polyolefins and powdered polyolefin waxes.

U.S. Pat. No. 3,528,841 discloses coating polymer pellets with polyolefin powders having an average particle size of less than 10 microns, and also being devoid of particle sizes greater than 25 microns, to reduce tackiness.

### SUMMARY OF INVENTION

This present invention is an improved process in which a small amount of non-volatile binder is sprayed onto the polymer pellet surface before applying the anti-tack powder. The binder is preferably a non-volatile liquid at ambient temperature, or a solid with a melting point less than 50 degrees C.

Binders used for coating the polymer pellet in the present invention may be selected from a group of organic, non-volatile oils and plasticizers including triglycerides (animal and vegetable fats), mono-/di-glycerides, acetylated mono-/di-glycerides, fatty acids, epoxidized triglycerides, phthalates, benzoates, sebacates, citrates, mineral oils, lactates, and combinations thereof.

Anti-tack or partitioning agents used to coat the polymer pellet in the present invention include talc, magnesium silicate, calcium silicate, calcium carbonate, cellulose, wood fiber, polyolefin wax, silica and combinations thereof. These anti-tack agents are typically in the form of a fine powder with a typical particle size of about 0.1 to about 20 microns.

Some applications of the present invention are for manufacturing soft and tacky polymer materials including chewing gum bases, hot-melt adhesives, sealants, powdered rubber, rubber masterbatch and other soft or tacky polymer materials.

It may be desirable to use a minimum amount of binder to prevent runoff when the binder is applied, and to minimize the effect of the binder on the final product. In addition it may be desirable to choose binders and/or anti-tack agents which may be in the formulation of the final product in which the polymer pellet is to be used.

In an embodiment, polymer pellets are coated with a binder at a level from about 0.01% to about 10% by weight of the polymer pellet.

In another embodiment, polymer pellets are coated with a binder at a preferable level from about 0.05% to about 1.0% by weight of the polymer pellet.

In an embodiment, polymer pellets are coated with an anti-tack or partitioning agent at a level from about 0.55% to about 20% by weight of the polymer pellet.

In another embodiment, polymer pellets are coated with an anti-tack or partitioning agent at a level from about 1% to about 10% by weight of the polymer pellet.

In an embodiment of the present invention, a polymer pellet having reduced tackiness comprises a polymer core, a first coating of a binder and a second coating of an anti-tack agent.

The coating process of the present invention, may be carried out in a P—K Zig-Zag Continuous Blender (available through Patterson-Kelley), or equivalent, with the binder being sprayed and coated onto the pellets first before applying the anti-tack powder.

The coating process may also be carried out in a batch V blender with the binder being coated first, before applying the anti-blocking powder.

The coating process of the present invention may also be performed in a rotating drum or any other standard coating practice in the art.

### DETAILED DESCRIPTION

Polymeric materials are indispensable components of many consumer, industrial, and food products. For instance, hot-melt adhesives and sealants are widely used in auto and furniture assembly. They are basically mixtures of polymeric elastomer and low-molecular weight resin tackifiers. Other elastomers, elastomer compounds or soft plastics or plastics blends are also used in manufacturing many products from auto tires to rubber hoses to roof shingles, etc.

In the food area, chewing gum is another example. Chewing gum is actually a mixture of a water-insoluble chewable gum base, a water-soluble sweetener and a flavoring agent. The water-insoluble chewing gum base is compounded from polymeric elastomers, resin plasticizers, mineral fillers, fats, waxes, etc. Normally it is manufactured in a separate step in advance of the final chewing gum product because much higher temperature and torque are typically required to process the elastomer.

For easier downstream handling, these polymeric materials are often manufactured into a pellet or granule form. A common practice is to pelletize the material with an underwater pelletizer, then separate the water in a spin dryer. Some materials such as chewing gum base, hot-melt adhesive, sealant, and other elastomer blends may be tacky at warm ambient conditions. An anti-tack or partitioning agent is sometimes thus used to prevent sticking and maintain the free-flow property. Common choices of anti-tack agents include fine powder of talc, magnesium silicate, calcium silicate, calcium carbonate, silica, cellulose powder, wood fiber, polyethylene wax etc.

In the case of underwater pelletization, the small amount of moisture on the pellet surface after exiting the pelletizer helps hold the anti-tack or partitioning agent onto the pellet surface. However, the moisture may slowly evaporate during storage and transportation, which causes the anti-tack powder fall off the pellet surface. As a consequence, the pellet may become tacky and get blocked, and the free anti-tack powder may also be a hazard dust to the downstream working environment.

This invention presents an improved process in which a small amount of liquid binder is sprayed to the polymer pellet surface before applying the anti-tack powder. The binder is preferably a non-volatile liquid at ambient, or a solid with a melting point lower than 50 degrees C. so it can be melted to a liquid easily. The liquid binder is selected to not interfere with the downstream processing and compounding operations. The component may be chosen to serve additional purpose in the final composition, e.g. plasticizer, softener, emulsifier etc.

Binders used in non-food applications of the present invention include monoglycerides, diglycerides, triglycerides, acetylated monoglycerides, acetylated diglycerides, fatty acids, epoxidized triglycerides, benzoates, tallates, phthalates, citrates, mineral oils, sebacates, lactates, other plasticizers and combinations thereof. The viscosity of the binder should not be so high as to make it non-pumpable.

Anti-tack agents used in non-food applications of the present invention include fine mineral and organic powders including talc, calcium carbonate, magnesium carbonate, ground limestone, magnesium silicate, calcium silicate, magnesium and aluminum silicate, clay, alumina, silica, carbon black, titanium oxide, monocalcium phosphate, dicalcium phosphate, tricalcium phosphate, polyolefin wax, oat fiber, wood fiber, apple fiber, zein, gluten, gliadin, casein, starch, starch zanthate and combinations thereof.

Binders used in food applications of the present invention may be organic, non-volatile oils and plasticizers including triglycerides (animal and vegetable fats), monoglycerides, diglycerides, triglycerides, acetylated monoglycerides, acetylated diglycerides, fatty acids and combinations thereof.

Binders used in the present invention are used in amounts of about 0.01% to about 10% by weight of the polymer pellet. Preferably, the binder is used in amounts of about 0.05% to about 1.0% by weight of the polymer pellet.

Anti-tack agents used in food applications of the present invention may be food-grade fine mineral and organic powders, including talc, calcium carbonate, magnesium carbonate, ground limestone, magnesium and aluminum silicate, clay, alumina, titanium oxide, monocalcium phosphate, dicalcium phosphate, tricalcium phosphate, oat fiber, wood fiber, apple fiber, zein, gluten, gliadin, casein, polyethylene wax, starch and combinations thereof.

The anti-tack agents for the present invention generally have an average particle size of about 0.1 microns to about 100 microns. Preferably, the average particle size is from about 0.1 microns to about 20 microns. The anti-tack agents are used in amounts of about 0.5% to about 20% by weight of the polymer pellet. Preferably, the anti-tack agent is used in amounts of about 1% to about 10% by weight of the polymer pellet.

Laboratory examples of the process differ from the typical processes and are detailed in the Examples below. These are presented to exemplify embodiments of the present invention and in no way limit the scope of the present invention. All of the gum bases used in the following examples are commercial gum bases.

### COMPARATIVE EXAMPLE 1

(Control-Wicks BBT Base):To a one-gallon Dry Powder Rotator (Model 099A-RD9912 from Glas-Col, Terre Haute, Ind.), 500 grams of Wicks BBT gum base (L. A. Dreyfus Company, Edison, N.J.) were loaded. The gum base has a softening point of 53-61 degrees C. The gum base was in a pellet form with a diameter about 10 mm. After spraying 1.5 grams of distilled water (0.3% by weight to the gum base) over the gum base, it was shaken for two minutes. This provides the controlled level of moisture to mimic the condition of that fresh out of the spin-dryer. Then, 20 grams (4% by weight to the gum base) of talc (MP 50-30 USP from Barretts Minerals, Barretts, Mont.) was added, and was shaken for another two minutes before discharge. Some talc coating was on the pellet surface but about half of the talc powder remained free.

### EXAMPLE 2

(0.06% conjugated linoleic acid):To a one-gallon Dry Powder Rotator (Model 099A-RD9912 from Glas-Col, Terre Haute, Ind.), 500 grams of Wicks BB gum base (L. A. Dreyfus Company, Edison, N.J.) were loaded. The gum base has a softening point of 53-61 degrees C. The gum base is in a pellet form with a diameter about 10 mm. After spraying 1.5 grams of distilled water (0.3% by weight to the gum base) over the gum base, it was shaken for two minutes. This provides the controlled level of moisture to mimic the condition of that fresh out of the spin-dryer. Then, 0.3 grams (0.06% by weight to the gum base) of conjugated linoleic acid (Neobee CLA-80 from Stepan Company, Maywood, N.J.) was sprayed over, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was uniform on the pellet surface with small amount (<20%) of free talc powder.

### EXAMPLES 3

(0.12% conjugated linoleic acid):To a one-gallon Dry Powder Rotator (Model 099A-RD9912 from Glas-Col, Terre Haute, Ind.), 500 grams of Wicks BBT gum base (L. A. Dreyfus Company, Edison, N.J.) were loaded. The gum base has a softening point of 53-61 degrees C. The gum base was in a pellet form with a diameter about 10 mm. After spraying 1.5 grams of distilled water (0.3% by weight to the gum base) over the gum base, it was shaken for two minutes. This provides the controlled level of moisture to mimic the condition of that fresh out of the spin-dryer. Then, 0.6 grams (0.12% by weight to the gum base) of conjugated linoleic acid (Neobee CLA-80 from Stepan Company, Maywood, N.J.) was sprayed, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was very uniform on the pellet surface with no free talc powder remaining.

### COMPARATIVE EXAMPLE 4

(Control Base A):To a one-gallon Dry Powder Rotator (Model 099A-RD9912 from Glas-Col, Terre Haute, Ind.), 500 grams of Gum Base A having a softening point of 62-75 degrees C. were loaded. The gum base was in a pellet form with a diameter about 10 mm. After spraying 1.5 grams of distilled water (0.3%) over the base, it was shaken for two minutes. This provides the controlled level of moisture to mimic the condition of that fresh out of the spin-dryer. Then, 20 grams (4% by weight to the gum base) of talc (MP 50-30 USP from Barretts Minerals, Barretts, Mont.) was added, and was shaken for another two minutes before discharge. Some talc coating was on the pellet surface, but about half of the talc powder remained free.

### EXAMPLE 5

(0.06% acetylated mono-glyceride):To a one-gallon Dry Powder Rotator (Model 099A-RD9912 from Glas-Col, Terre Haute, Ind.), 500 grams of Gum Base A having a softening point of 62-75 degrees C. were loaded The gum base was in a pellet form with a diameter about 10 mm. After spraying 1.5 grams of distilled water (0.3% by weight to the gum base) over the base, it was shaken for two minutes. This provides the controlled level of moisture to mimic the condition of that fresh out of the spin-dryer. Then, 0.3 grams (0.06% by weight to the gum base) of acetylated mono-glyceride (Acetem 90-50 from Danisco Ingredients USA, Inc., New Centry, Kans.) was sprayed, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was uniform on the pellet surface with a small amount (<20%) of free talc powder.

### EXAMPLE 6

(0.12% acetylated mono-glyceride):a one-gallon Dry Powder Rotator (Model 099A-RD9912 from Glas Col, Terre Haute, Ind.), 500 grams of Gum Base A having a softening point of 62-75 degrees C. were loaded. The gum base was in a pellet form with a diameter about 10 mm. After spraying 1.5 grams of distilled water (0.3% by weight to the gum base) over the base, it was shaken for two minutes. This provides the controlled level of moisture to mimic the condition of that fresh out of the spin-dryer. Then, 0.6 grams (0.12% by weight to the gum base) of acetylated mono-glyceride (Acetem 90-50 from Danisco Ingredients USA, Inc., New Centry, Kans.) was sprayed, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was very uniform on the pellet surface with no free talc powder remaining.

### EXAMPLE 7

(0.12% safflower oil):To a one-gallon Dry Powder Rotator (Model 099A-RD9912 from Glas-Col, Terre Haute, Ind.), 500 grams of Gum Base B having a softening point of 52-62 degrees C. were loaded The gum base was in a pellet form with a diameter about 10 mm. After spraying 1.5 grams of distilled water (0.3% by weight to the gum base) over the gum base, it was shaken for two minutes. This provides the controlled level of moisture to mimic the condition of that fresh out of the spin-dryer. Then, 0.6 grams (0.12% by weight to the gum base) of safflower oil (Food Ingredients, Inc., Hamshire, Ill.) was sprayed, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was very uniform on the pellet surface with no free talc powder remaining.

### EXAMPLE 8

(0.12% corn oil):To a one-gallon Dry Powder Rotator (Model 099A-RD9912 from Glas-Col, Terre Haute, Ind.), 500 grams of Gum Base B having a softening point of 52-62 degrees C. were loaded The gum base was in a pellet form with a diameter about 10 mm. After spraying 1.5 grams of distilled water (0.3% by weight to the gum base) over the gum base, it was shaken for two minutes. This provides the controlled level of moisture to mimic the condition of that fresh out of the spin-dryer. Then, 0.6 grams (0.12% by weight to the gum base) of corn oil (Archer Daniels Midland Company, Decatur, Ill.) was sprayed, and it was shaken for another two minutes. Finally, 20 grams (4% by weight to the gum base) of talc (MP 50-30 USP from Barretts Minerals, Barretts, Mont.) was added, and was shaken for another two minutes before discharge. The talc coating was very uniform on the pellet surface with no free talc powder remaining.

Table 1 summarizes the screening results on other binders and gum base as well. There are several conclusions can be drawn from it: (1) Hydrophilic binders like glycerol and inulin did not provide adequate improvements., possibly because the gum bases are largely hydrophobic.(2) It seems that 0.06% binder (to the gum base) is too low, but 0.20% is too high. The right binder level is about 0.12% by weight to the gum base (or about 3% by weight to the anti-tack talc). (3) Vegetable oils (tri-glycerides), acetylated mono-glycerides, and conjugated linoleic acid generally worked well. Gum Base A is a gum base with a softening point of 62-75 degrees C. Gum Base B is a gum base with a softening point of 52-62 degrees C. Gum Base C is a gum base with a softening point of 56-62 degrees C.

It was also interesting to see that polar conjugated linoleic acid and acetylated mono-glycerides worked better for high-polarity gum base (Gum Base B) and talc base (Wicks-BBT than the non-polar tri glycerides (vegetable oils), while vegetable oils worked better for low-polarity bases (Gum Base A and Gum Base C) and CaCO₃ base (Wicks-BB). The values indicated in the table are: −2 is much worse than control; −1 is worse than control; 0 is same as control; 1 is better than control; 2 is much better than control.

[t1]

Performance of Coatings with Binders

| | | Wicks | Gum | Gum | Gum | Wicks |
|---|---|---|---|---|---|---|
| Binder | Level | BBT | Base A | Base B | Base C | BB |
| Glycer- | 0.06% | −2 | −1 | | | |
| ol | | | | | | |
| (96%) | | | | | | |
| Glycer- | 0.12% | −1 | −1 | | | |
| ol | | | | | | |
| (96%) | | | | | | |
| Acetyl- | 0.06% | 1 | 1 | | | |
| ated | | | | | | |
| mono- | | | | | | |
| glycer- | | | | | | |
| ide | | | | | | |
| (96% | | | | | | |
| acetyl- | | | | | | |
| ation) | | | | | | |
| Acetyl- | 0.12% | 2 | 1 | 2 | 1 | |
| ated | | | | | | |
| mono- | | | | | | |
| glycer- | | | | | | |
| ide | | | | | | |
| (96% | | | | | | |
| acetyl- | | | | | | |
| ation) | | | | | | |
| Acetyl- | 0.06% | 1 | 1 | | | |
| ated | | | | | | |
| mono- | | | | | | |
| glycer- | | | | | | |
| ide | | | | | | |
| (90% | | | | | | |
| acetyl- | | | | | | |
| ation) | | | | | | |
| Acetyl- | 0.12% | 2 | 2 | 2 | 2 | |
| ated | | | | | | |
| mono- | | | | | | |
| glycer- | | | | | | |
| ide | | | | | | |
| (90% | | | | | | |
| acetyl- | | | | | | |
| ation) | | | | | | |
| Conjug- | 0.06% | 1 | 1 | | | |
| ated lin- | | | | | | |
| oleic | | | | | | |
| acid | | | | | | |
| Conjug- | 0.12% | 2 | 2 | 2 | 2 | |
| ated lin- | | | | | | |
| oleic | | | | | | |
| acid | | | | | | |
| Soya oil | 0.06% | 0 | 1 | | | |
| Soya oil | 0.12% | 2 | 2+ | 1 | 2 | 2 |
| Soya oil | 0.20% | | | | | |
| Saff- | 0.06% | 1 | 1 | | | |
| lower | | | | | | |
| oil | | | | | | |
| Saff- | 0.12% | 1 | 2+ | 2 | 2 | 2 |
| lower | | | | | | |
| oil | | | | | | |
| Corn oil | 0.06% | 1 | 1 | | | |
| Corn oil | 0.12% | 1 | 2 | 1 | 2 | 2 |
| Inulin | 0.20% | 0 | | | | |

Scaled up experiments were also performed. Examples 9 and 10 used about 400 LB/hour of gum base pellets. One example was performed in a one-step continuous process and the other in a two step continuous process.

### EXAMPLE 9

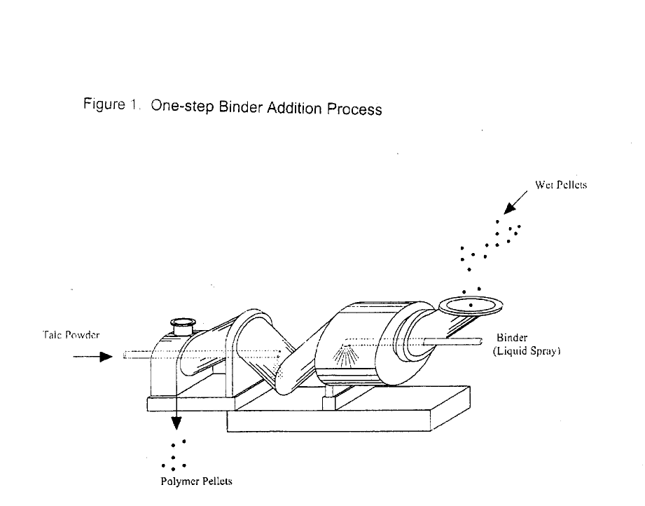

(One-step continuous process):A 3V, 8 inch zig-zag blender was used (Patterson-Kelley, East Stroudsburg, Pa.). See FIG. 1 for a schematic of this process. The wet Gum Base A pellets having softening point of 62-75 degrees C., with a surface moisture of 0.3% were added at about 400 LBs/hr continuously while the binder (soya oil) was sprayed at a rate of 0.12% of the base pellets, and talc was fed at 4% of the base pellets. The binder was sprayed at the front of the zig-zag while the talc powder was added through a screw feeder to the middle of the zig-zag. FIG. 1 illustrates the test layout. The talc coating adhered better with the binder than without the binder.

The resulting coating of the pellets was slightly more uniform and durable than those without the binder. However, there was still a significant amount of free talc powder. It seems that this was due to insufficient coating time of the binder before introducing the talc powder.

### EXAMPLE 10

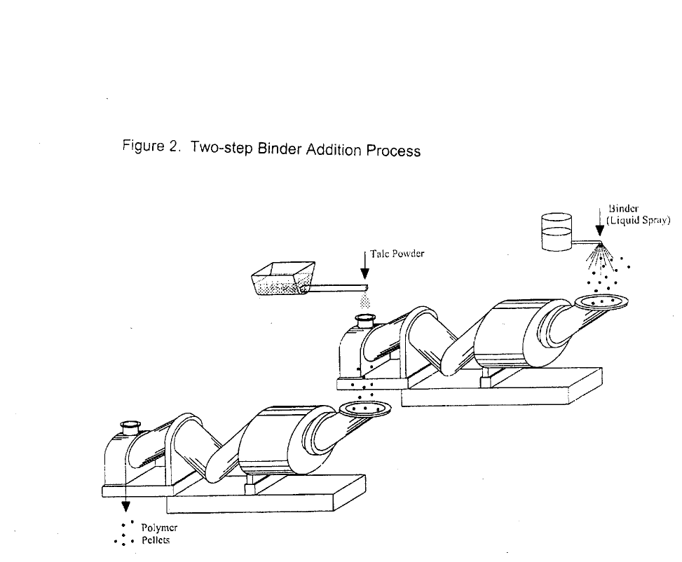

(Two-step continuous process):The test was done in two 3V, 8 inch Patterson-Kelley zig zag blenders. See FIG. 2 for a schematic of this process. The pre-wet gum base pellets (Gum Base C), having softening point of 56-62 degrees C., were coated with a binder (soya oil) in the first zig-zag blender, then the talc powder was added in the second zig-zag blender, as illustrated in FIG. 2. Two variables were changed: binder levels and moisture levels. It was found that at higher binder level (0.2% by weight), the coating was not uniform, although no free powder remained. The talc coating looked wet. This suggested that the binder/talc ratio was too high. With a binder level of 0.12% by weight and no moisture, there was some free talc powder. The best combination was 0.12% by weight binder (soya oil) and 0.3% by weight moisture by weight of the gum base pellets. The coating was very uniform and durable. After one month, the talc coating was not even removable with water.

1. A process for coating a tacky or soft polymer pellet comprising the steps of
a.) coating said polymer pellet with a binder, and
b.) adhering an anti-tack agent to said binder.

2. The process of claim 1, wherein the tackiness of said pellet is reduced.

3. The process of claim 1, wherein said polymer pellet is a food-grade material.

4. The process of claim 1, wherein said polymer pellet is a non-food material.

5. The process of claim 3, wherein said polymer pellet material is chewing gum base.

6. The process of claim 1, wherein said polymer pellet has a diameter of about 1 mm to about 100 mm.

7. The process of claim 1, wherein said polymer pellet has a diameter of about 3 mm to about 20 mm.

8. The process of claim 3, wherein said binder is selected from the group consisting of food-grade monoglycerides, diglycerides, triglycerides, and acetylated monoglycerides, acetylated diglycerides, fatty acids and combinations thereof.

9. The process of claim 3, wherein said anti-tack agent is a food-grade fine mineral powder.

10. The process of claim 9, wherein said food-grade fine mineral powder is selected from the group consisting of talc, calcium carbonate, magnesium carbonate, ground limestone, magnesium silicate, aluminum silicate, clay, alumina, titanium oxide, mono-calcium phosphate, di-calcium phosphate, tri-calcium phosphate and combinations thereof.

11. The process of claim 3, wherein said anti-tack agent is a food-grade organic powder.

12. The process of claim 11, wherein said food-grade organic powder is selected from the group consisting of oat fiber, wood fiber, apple fiber, zein, gluten, gliadin, casein, starch, cellulose powder, polyethylene wax and combinations thereof.

13. The process of claim 1, wherein said anti-tack agent is a powder having an average particle size of about 0.1 μm to about 100 μm.

14. The process of claim 1, wherein said anti-tack agent is a powder having an average particle size of about 0.1 μm to about 20 μm.

15. The process of claim 1, wherein said binder is coated to a level of about 0.01% to about 10% by weight of said polymer pellet.

16. The process of claim 1, wherein said binder is coated to a level of bout 0.05% to about 1.0% by weight of said polymer pellet.

17. The process of claim 1, wherein said anti-tack agent is coated to a level of about 0.5% to about 20% by weight of said polymer pellet.

18. The process of claim 1, wherein said, anti-tack agent is coated to a level of about 1% to about 10% by weight of said polymer pellet.

19. The process of claim 1, wherein said coating process is carried out in a zig-zag continuous blender wherein the binder is added through a sprayer at the front of said blender, and the anti-tack powder is added in the middle of said blender.

20. The process of claim 1, wherein said coating process is carried out in two zig-zag continuous benders wherein the binder is added through a sprayer at the front of the first said blender and the anti-tack agent is added at the front of the second said blender.

21. The process of claim 4, wherein said polymer pellet is selected from the group consisting of hot-melt adhesives, sealants, elastomers, elastomer compounds, soft plastics and plastic blends.

22. The process of claim 4, wherein said binder is a non-volatile, organic compound selected from the group consisting of monoglycerides, diglycerides, triglycerides, acetylated monoglycerides, acetylated diglycerides, fatty acids, epoxidized triglycerides, benzoates, tallates, phthalates sebacates, citrates, mineral oils, lactates and combinations thereof.

23. The process of claim 4, wherein said anti-tack agent is a fine mineral powder.

24. The process of claim 23, wherein said fine mineral powder is selected from the group consisting of talc, calcium carbonate, magnesium carbonate, ground limestone, magnesium silicate, calcium silicate, magnesium and aluminum silicate, clay, alumina, silica, carbon black, titanium oxide, monocalcium phosphate, dicalcium phosphate, tricalcium phosphate, and combinations thereof.

25. The process of claim 4, wherein said anti-tack agent is a organic powder.

26. The process of claim 25, wherein said anti-tack agent is a organic powder selected from the group consisting of oat fiber, wood fiber, apple fiber, zein, gluten, gliadin, casein, cellulose powder, polyolefin wax, starch, starch zanthate and combinations thereof.

27. The process of claim 1, wherein said coating process is performed in a batch V blender with binder being applied first to said polymer pellet and the anti-tack agent being applied second to said polymer pellet.

28. A polymer pellet having reduced tackiness comprising;
a.) a core comprising a polymer,
b.) a first coating of a binder on said core, and
c.) a second coating of an anti-tack agent on said binder coated core.

29. The polymer pellet of claim 28, wherein said polymer core is a food-grade material.

30. The polymer pellet of claim 28, wherein said polymer core is a non-food material.

31. The polymer pellet of claim 29, wherein said polymer core is chewing gum base.

32. The polymer pellet of claim 28, wherein said polymer core has a diameter of about 1 mm to about 100 mm.

33. The polymer pellet of claim 28, wherein said polymer core has a diameter of about 3 mm to about 20 mm.

34. The polymer pellet of claim 29, wherein said binder is selected from the group consisting of food-grade monoglycerides, diglycerides, triglycerides, and acetylated monoglycerides, acetylated diglycerides, fatty acids and combinations thereof.

35. The polymer pellet of claim 29, wherein said anti-tack agent is a food-grade fine mineral powder.

36. The polymer pellet of claim 35, wherein said food-grade fine mineral powder is selected from the group consisting of talc, calcium carbonate, magnesium carbonate, ground limestone, magnesium silicate, aluminum silicate, clay, alumina, titanium oxide, mono-calcium phosphate, di-calcium phosphate, tri-calcium phosphate and combinations thereof.

37. The polymer pellet of claim 29, wherein said anti-tack agent is a food-grade organic powder.

38. The polymer pellet of claim 37, wherein said food-grade organic powder is selected from the group consisting of oat fiber, wood fiber, apple fiber, zein, gluten, gliadin, casein, cellulose powder, polyethylene wax, starch and combinations thereof.

39. The polymer pellet of claim 28, wherein said anti-tack agent is a powder having an average particle size of about 0.1 μm to about 100 μm.

40. The polymer pellet of claim 28, wherein said anti-tack agent is a powder having an average particle size of about 0.1 μm to about 20 μm.

41. The polymer pellet of claim 28, wherein said binder is coated to a level of about 0.01% by weight to about 10% by weight of said polymer core.

42. The polymer pellet of claim 28, wherein said binder is coated to a level of about 0.05% by weight to about 1.0% by weight of said polymer core.

43. The polymer pellet of claim 28, wherein said anti-tack agent is coated to a level of about 0.5% by weight to about 20% by weight of said polymer core.

44. The polymer pellet of claim 28, wherein said anti-tack agent is coated to a level of about 1% by weight to about 10% by weight of said polymer core.

45. The polymer pellet of claim 28, wherein said polymer core is coated in a zig-zag continuous blender wherein the binder is added through a sprayer at the front of said blender, and the anti-tack powder is added in the middle of said blender.

46. The polymer pellet of claim 28, wherein said polymer core is coated in two zig-zag continuous benders wherein the binder is added through a sprayer at the front of the first said blender and the anti-tack agent is added at the front of the second said blender.

47. The polymer pellet of claim 28, wherein said polymer core is coated in a batch V blender with binder being applied first to said polymer core and the anti-tack agent being applied second to said polymer core.
